(19) United States
(12) Patent Application Publication
(10) Pub. No.: US 2018/0011174 A1
(43) Pub. Date: Jan. 11, 2018

(54) POSITION REFERENCE SENSOR

(71) Applicant: GUIDANCE MARINE LIMITED, Leicester, Leicestershire (GB)

(72) Inventors: Russell MILES, Leicester (GB); David MCKNIGHT, Leicester (GB)

(73) Assignee: GUIDANCE MARINE LIMITED, Leicester, Leicestershire (GB)

(21) Appl. No.: 15/545,595

(22) PCT Filed: Jan. 21, 2016
(86) PCT No.: PCT/GB2016/050128

§ 371 Date: Jul. 21, 2017

(30) Foreign Application Priority Data
Jan. 23, 2015 (GB) 1501154.7

(51) Int. Cl. G01S 7/486; G01S 7/499; G01S 7/481; G01S 17/10; G01J 1/44

(52) U.S. Cl. CPC G01S 7/4861; G01S 17/10; G01J 1/44; G01S 7/4817; G01S 7/499

(57) ABSTRACT

A position reference sensor (100) has a light source (120), a detector (160) and a processor (170). The light source (120) is configured to emit light having a first component and a second component. The detector (160) is configured to detect reflected light. The processor (170) is configured to determine a distance between the position reference sensor (100) and a target based on the emitted light and the detected reflected light. The processor (170) is also configured to determine that the target is a selective retroreflector (140) based on the intensity of the first component of the light in the detected reflected light and the intensity of the second component of the light in the detected reflected light.

### FIELD OF THE INVENTION

The present invention relates to a position reference sensor, for example, a position reference sensor for use in marine applications for determining the position of a vessel relative to an object. The present invention also relates to a position reference system.

### BACKGROUND OF THE INVENTION

Position reference sensors are used to determine position information indicating the position of a vessel relative to another object, such as another vessel or a fixed or floating platform, like an oil rig. Position information from a position reference sensor can be used by a dynamic positioning system to control the position of the vessel relative to the object. The dynamic positioning system may, for example, maintain a fixed relative position between the vessel and the object without the need for a physical connection between the vessel and the object to provide a virtual tether, for example, in a cable laying convoy. Alternatively, the dynamic positioning system can move the vessel relative to the object, for example, to dock a vessel with an oil rig.

A position reference sensor emits a pulsed laser beam which is reflected back from a retroreflective target attached to an object. The position reference sensor determines the distance between the position reference sensor and the object by measuring the time of flight between emission and detection of a laser pulse. A bearing can also be obtained by measuring the rotational orientation of the position reference sensor, for example, using an encoded rotation stage to which the position reference sensor is mounted.

The retroreflective target reflects the laser pulse straight back to the position reference sensor without increasing the divergence of the laser pulse, maximising the intensity of the laser pulse reflected back to the position reference sensor to help distinguish the laser pulse from background light.

However, problems can occur when the laser pulse is reflected from reflective surfaces or elements on the object other than the retroreflective target. There are often other retroreflective surfaces on, or attached to, the object which can lead to unwanted reflections, for example, some objects are marked with retroreflective tape, some signs are made from retroreflective material, and the reflectors in flood lights can act as retroreflectors. Unwanted reflections can also happen when the pulsed laser beam hits, for example, shiny metal surfaces or a glass window, which may in certain circumstances produce a similarly intense reflection to the retroreflective target. The position reference sensor will assume that any reflected laser pulses it receives are from a retroreflective target and will calculate the distance between the position reference sensor and the unwanted reflection.

A problem is that the unwanted reflection is unlikely to provide a stable and strong reflection which would provide a reliable retroreflective target, for example, the unwanted reflection may not be visible over a wide range of viewing angles, so if the position of the vessel relative to the object changes, the reflection may disappear. Additionally, the unwanted reflection may move relative to the object, for example, if the unwanted reflection came from retroreflective tape or markings on a crane, or a high-visibility jacket worn by a rig worker. The unwanted reflection may also be from an entirely different object.

A current solution to this problem of unwanted reflections is to ask a user to confirm that a reflection is coming from a retroreflective target on an object, and is not an unwanted reflection. However, asking for user confirmation is inconvenient and time consuming, and may be prone to error.

It would be advantageous to find a way to distinguish a reflection from a retroreflective target from unwanted reflections without requiring user intervention.

### SUMMARY OF THE INVENTION

According to a first aspect of the invention, there is provided a position reference sensor. The position reference sensor comprises a light source, a detector and a processor. The light source is configured to emit light having a first component and a second component. The detector is configured to detect reflected light. The processor is configured to determine a distance between the position reference sensor and a target based on the emitted light and the detected reflected light. The processor is further configured to determine that the target is a selective retroreflector based on the intensity of the first component of the light in the detected reflected light and the intensity of the second component of the light in the detected reflected light.

An advantage of the fact that the light source is configured to emit light having a first component and a second component, that the processor is configured to determine a distance between the position reference sensor and a target based on the emitted light and the detected reflected light, and that the processor is configured to determine that the target is a selective retroreflector based on the intensity of the first component of the light in the detected reflected light and the intensity of the second component of the light in the detected reflected light means that the position reference sensor is able to identify reflections that have come from a selective retroreflector and distinguish them from unwanted reflections. Measuring the distance between a position reference sensor and a selective retroreflector which may be fixed to an object is likely to provide a more reliable and stable indication of the distance between the position reference sensor and the object than measuring the distance between a position reference sensor and an unwanted reflection on the object, because the unwanted reflection may move relative to the object or the unwanted reflection may not be viewable over a wide-range of angles. The fact that the position reference sensor is able to identify reflections that have come from a selective retroreflector and distinguish them from unwanted reflections may eliminate the need for user intervention to identify a suitable retroreflective target.

The processor may be further configured to determine a ratio of the intensity of the first component of the light in the detected reflected light to the intensity of the second component of the light in the detected reflected light. The ratio may indicate whether the target is a selective retroreflector, or an unwanted reflection. For example, a ratio indicating that the intensity of the first component of the light in the detected reflected light is significantly higher than the intensity of the second component of the light in the detected reflected light may indicate that the target is a selective retroreflector. In contrast, a ratio indicating that the intensity of the first component of the light in the detected reflected light is similar to the intensity of the second component of the light in the detected reflected light may indicate that the target is an unwanted reflection.

The processor may be further configured to determine that the target is a selective retroreflector when the ratio of the intensity of the first component of the light in the detected reflected light to the intensity of the second component of the light in the detected reflected light is above an identification threshold. The identification threshold may be set so as to distinguish between targets which are, or are considered likely to be, selective retroreflectors, and targets which are, or might be, unwanted reflections.

The processor may be further configured to set and/or adjust the identification threshold based on the intensity of the first component of the light in the detected reflected light and/or the intensity of the second component of the light in the detected reflected light. The identification threshold may be adjusted to optimize discrimination between unwanted reflections and reflections from a selective retroreflector, while avoiding false results. For example, the identification threshold may be reduced when the intensity of the first component of the light in the detected reflected light and/or the intensity of the second component of the light in the detected reflected light is reduced.

The processor may be further configured to determine that the target is a selective retroreflector when the intensity of the first component of the light in the detected reflected light is above a first detection threshold and the intensity of the second component of the light in the detected reflected light is above a second detection threshold. The use of a detection threshold reduces the likelihood that background light (which has not come from the selective retroreflector), or noise on the detector, could lead to an erroneous determination that the target is a selective retroreflector.

The processor may be further configured to determine that the target is a selective retroreflector when the intensity of the first component of the light in the detected reflected light is above a first detection threshold and the intensity of the second component of the light in the detected reflected light is below a second detection threshold and the ratio of the intensity of the first component of the light in the detected reflected light to the second detection threshold is above the identification threshold.

The first detection threshold and the second detection threshold may be the same.

The first component of the emitted light may have a first wavelength and the second component of the emitted light may have a second wavelength. The first wavelength and the second wavelength may be any wavelengths, so long as the selective retroreflector reflects light of the first wavelength and not light of the second wavelength, or absorbs light of the second wavelength and not light of the first wavelength.

The first wavelength and the second wavelength may be chosen such that atmospheric absorption is similar for both the first wavelength and the second wavelength.

The first wavelength and the second wavelength may be in the range of 850 nm to 2000 nm. The first wavelength may be one of: 850 nm, 870 nm, 905 nm, 940 nm, 1064 nm, 1550 nm or 2000 nm. The second wavelength may be one of: 850 nm, 870 nm, 905 nm, 940 nm, 1064 nm, 1550 nm or 2000 nm.

The light source may be a single laser configured to generate the light of the first wavelength and the light of the second wavelength. Alternatively, the light source may be a first laser configured to generate the light of the first wavelength and a second laser configured to generate the light of the second wavelength.

One or more of the lasers may be a diode laser, such as: Laser Components 850D1S06x; Laser Components 905D; Osram 850 SPL PL85; Osram 905 SPL PL90; Hamamatsu L11348-307-05; or Hamamatsu L11854-307-05.

One or more of the lasers may be a Vertical Cavity Surface Emitting Laser array, which may operate in the range 900 nm-1000 nm.

One or more of the lasers may be a pulsed ND:YAG laser operating at 1064 nm.

One or more of the lasers may be a fibre laser operating at either 1550 nm or 2000 nm.

The first component of the light may have a first polarization state and the second component of the light may have a second polarization state. The first polarization state and the second polarization state may be any polarization states, so long as the selective retroreflector reflects light of the first polarization state and not light of the second polarization state, or absorbs light of the second polarization state and not light of the first polarization state.

The first polarization state may be a linear polarization state with a first polarization axis. The second polarization state may be a linear polarization state with a second polarization axis which is orthogonal, or rotated, relative to the first polarization axis.

The first polarization state may be a left-handed circular, or elliptical, polarization state and the second polarization state may be a right-handed circular, or elliptical, polarization state. Alternatively, the first polarization state may be a right-handed circular, or elliptical, polarization state and the second polarization state may be a left-handed circular, or elliptical, polarization state.

The light source may further comprise a laser configured to generate the light of the first polarization state and an optical element configured to generate the light of the second polarization state from the light of the first polarization state. The optical element may be a half-wave plate and a polarizer.

The light source may further comprise a first laser and a first optical element configured to generate the light of the first polarization state, and a second laser and a second optical element configured to generate the light of the second polarization state. The first optical element configured to generate the light of the first polarization state and the second optical element configured to generate the light of the second polarization state may comprise half-wave plates and polarizers, and/or quarter-wave plates.

The light source may further comprise a first laser having a polarization axis, and a second laser having a polarization axis, where the polarization axis of the second laser is rotated with respect to the polarization axis of the first laser. This is a straightforward and convenient way to provide a first and second polarization state, for example, by using the same laser for the first and second laser and physically rotating the second laser around the optical axis with respect to the first laser.

The light source may further comprise a beam combiner configured to combine the first and second components into a single beam.

The position reference sensor may further comprise a first telescope placed between the first laser and the beam combiner and a second telescope placed between the second laser and the beam combiner. This provides a straightforward, and high performance, means to control the size and divergence of the single beam, for example, to collimate the single beam so that is does not spread too wide before reaching a target. Alternatively, the position reference sensor may further comprise a single telescope placed after the beam combiner, so that the single beam is collimated using a single telescope which provides a more compact optical arrangement.

In order for the position reference sensor to determine the intensity of the first component of the light in the detected reflected light and the intensity of the second component of the light in the detected reflected light, the detector may further comprise a beam splitter configured to separate the first and second components of the light in the detected reflected light onto respective first and second photodetectors. Alternatively, the processor may be further configured to sequentially switch on and off the emission of the first and second components of the light, and the detector may be configured to determine the intensity of the first component of the light in the detected reflected light in time periods where emission of the first component is switched on and emission of the second component is switched off, and to determine the intensity of the second component of the light in the detected reflected light in times periods where the emission of the second component is switched on and the emission of the first component is switched off.

The light source may be configured to pulse the first component of the light, and optionally the second component of the light, and the processor may be configured to determine the distance based on time of flight of the emitted light and the detected reflected light. Alternatively, the light source may be configured to amplitude modulate the first component of the light, and optionally the second component of the light, and the processor may be configured to determine the distance based on a phase measurement on the emitted light and the detected reflected light.

The position reference sensor may be further configured to rotate the light source and the detector. By rotating the light source and the detector, the position reference sensor may hunt or scan for a target. The light source and the detector may be rotated using a rotation stage. The processor may determine the distance based on an average of the distance determined for each rotation of the detector.

The position reference sensor may comprise a movable optical element configured to scan the emitted light. By scanning the emitted light, the position reference sensor may hunt or scan for a target. The movable optical element may be one or more of: one or more scanning mirrors, one or more spinning polygon mirrors, a Risley prism, a Risley prism pair, and a spinning wedged optic.

The processor may be further configured to determine a bearing of the emitted light, in order that a bearing to the target may be determined. The position reference sensor may further comprise an encoder configured to determine the bearing.

The position reference sensor may further comprise a rotation stage configured to adjust an elevation angle of the light source and the detector. In this way, the position reference sensor may hunt or search for a selective retroreflector.

The processor may be further configured to output a signal indicative of the distance. This signal may be used, for example, to control a dynamic positioning system.

The processor may be further configured to output a signal indicating that the target is a selective retroreflector.

According to a second aspect of the invention, there is provided a position reference system. The position reference system comprises a light source, a target, a position reference sensor and a processor. The light source is configured to emit light having a first component and a second component. The target is configured to be attachable to an object. The target is further configured to retroreflect the first component of the light and not the second component of the light. The position reference sensor comprises a detector configured to detect reflected light. The processor is configured to determine a distance between the position reference sensor and the target based on the emitted light and the detected reflected light. The processor is further configured to determine that the target is a selective retroreflector based on the intensity of the first component of the light in the detected reflected light and the intensity of the second component of the light in the detected reflected light.

An advantage of the fact that the light source is configured to emit light having a first component and a second component, that the target is configured to reflect the light of the first component and not the light of the second component, that the processor is configured to determine a distance between the position reference sensor and the target based on the emitted light and the detected reflected light, and that the processor is configured to determine that the target is a selective retroreflector based on the intensity of the first component in the detected reflected light and the intensity of the second component in the detected reflected light means that the position reference system is able to identify reflections that have come from a selective retroreflector and distinguish them from unwanted reflections. Measuring the distance between a position reference sensor and a selective retroreflector which is attachable to an object is likely to provide a more reliable and stable indication of the distance between the position reference sensor and the object than measuring the distance between a position reference sensor and an unwanted reflection from the object, because the unwanted reflection may move relative to the object or the unwanted reflection may not be viewable over a wide-range of angles. The fact that the position reference system is able to identify reflections that have come from a selective retroreflector and distinguish them from unwanted reflections may eliminate the need for user intervention to identify a suitable retroreflective target.

The processor may be further configured to determine a ratio of the intensity of the first component of the light in the detected reflected light to the intensity of the second component of the light in the detected reflected light. The ratio may indicate whether the target is a selective retroreflector, or an unwanted reflection. For example, a ratio indicating that the intensity of the first component of the light in the detected reflected light is significantly higher than the intensity of the second component of the light in the detected reflected light may indicate that the target is a selective retroreflector. In contrast, a ratio indicating that the intensity of the first component of the light in the detected reflected light is similar to the intensity of the second component of the light in the detected reflected light may indicate that the target is an unwanted reflection.

The processor may be further configured to determine that the target is a selective retroreflector when the ratio of the intensity of the first component of the light in the detected reflected light to the intensity of the second component of the light in the detected reflected light is above an identification threshold. The identification threshold may be set so as to distinguish between targets which are, or are considered likely to be, selective retroreflectors, and targets which are, or might be, unwanted reflections.

The processor may be further configured to set and/or adjust the identification threshold based on the intensity of the first component of the light in the detected reflected light and/or the intensity of the second component of the light in the detected reflected light. The identification threshold may be adjusted to optimize discrimination between unwanted reflections and reflections from selective retroreflector, while avoiding false results. For example, the identification threshold may be reduced when the intensity of the first component of the light in the detected reflected light and/or the intensity of the second component of the light in the detected reflected light is reduced.

The processor may be further configured to determine that the target is a selective retroreflector when the intensity of the first component of the light in the detected reflected light is above a first detection threshold and the intensity of the second component of the light in the detected reflected light is above a second detection threshold. The use of a detection threshold reduces the likelihood that background light (which has not come from the selective retroreflector), or noise on the detector, could lead to an erroneous determination that the target is a selective retroreflector.

The processor may be further configured to determine that the target is a selective retroreflector when the intensity of the first component of the light in the detected reflected light is above a first detection threshold and the intensity of the second component of the light in the detected reflected light is below a second detection threshold and the ratio of the intensity of the first component of the light in the detected reflected light to the second detection threshold is above the identification threshold.

The first detection threshold and the second detection threshold may be the same.

The selective retroreflector may comprise an optical component configured to reflect the first component of the light and not the second component of the light.

The first component of the emitted light may have a first wavelength and the second component of the emitted light may have a second wavelength. The first wavelength and the second wavelength may be any wavelengths, so long as the selective retroreflector reflects light of the first wavelength and not light of the second wavelength, or absorbs light of the second wavelength and not light of the first wavelength.

The optical component may be a dielectric mirror configured to reflect the first component of the light and not the second component of the light. Alternatively, the optical component may be a band pass filter or a wavelength-absorbing material placed in front of a broadband mirror, where the band pass filter or the wavelength-absorbing material is configured to allow only the first component of the light to reach, and be reflected by, the broadband mirror. The wavelength-absorbing material may be a coloured glass filter or a coloured acrylic filter. The band pass filter may be a bandpass dichoric filter.

The first wavelength and the second wavelength may be chosen such that atmospheric absorption is similar for both the first wavelength and the second wavelength.

The first wavelength and the second wavelength may be in the range 900 nm to 2000 nm. The first wavelength may be one of: 850 nm, 870 nm, 905 nm, 940 nm, 1064 nm, 1550 nm or 2000 nm. The second wavelength may be one of: 850 nm, 870 nm, 905 nm, 940 nm, 1064 nm, 1550 nm or 2000 nm.

The light source may be a single laser configured to generate the light of the first wavelength and the light of the second wavelength. Alternatively, the light source may be a first laser configured to generate the light of the first wavelength and a second laser configured to generate the light of the second wavelength.

One or more of the lasers may be a diode laser, such as: Laser Components 850D1S06x; Laser Components 905D; Osram 850 SPL PL85; Osram 905 SPL PL90; Hamamatsu L11348-307-05; or Hamamatsu L11854-307-05.

One or more of the lasers may be a Vertical Cavity Surface Emitting Laser array, which may operate in the range 900 nm-1000 nm.

One or more of the lasers may be a pulsed ND:YAG laser operating at 1064 nm.

One or more of the lasers may be a fibre laser operating at either 1550 nm or 2000 nm.

The first component of the light may have a first polarization state and the second component of the light may have a second polarization state. The first polarization state and the second polarization state may be any polarization states, so long as the selective retroreflector reflects light of the first polarization state and not light of the second polarization state, or absorbs light of the second polarization state and not light of the first polarization state.

The first polarization state may be a linear polarization state with a first polarization axis. The second polarization state may be a linear polarization state with a second polarization axis which is orthogonal, or rotated, relative to the first polarization axis.

The first polarization state may be a left-handed circular, or elliptical, polarization state and the second polarization state may be a right-handed circular, or elliptical, polarization state. Alternatively, the first polarization state may be a right-handed circular, or elliptical, polarization state and the second polarization state may be a left-handed circular, or elliptical, polarization state.

The optical component in the selective retroreflector may be a polarizing beamsplitter configured to reflect the first component of the light and not the second component of the light. Alternatively, the optical component in the selective retroreflector may be a polarizer placed in front of a broadband mirror, where the polarizer is configure to allow only the first component of the light to reach, and be reflected by, the broadband mirror.

The light source may further comprise a laser configured to generate the light of the first polarization state and an optical element configured to generate the light of the second polarization state from the light of the first polarization state. The optical element may be a half-wave plate and a polarizer.

The light source may further comprise a first laser and a first optical element configured to generate the light of the first polarization state, and a second laser and a second optical element configured to generate the light of the second polarization state. The first optical element configured to generate the light of the first polarization state and second optical element configured to generate the light of the second polarization state may comprise half-wave plates and polarizers, and/or quarter-wave plates.

The light source may further comprise a first laser having a polarization axis, and a second laser having a polarization axis, where the polarization axis of the second laser is rotated with respect to the polarization axis of the first laser. This is a straightforward and convenient way to provide a first and second polarization state, for example, by using the same laser for the first and second laser and physically rotating the second laser around the optical axis with respect to the first laser.

The light source may further comprise a beam combiner configured to combine the first and second components into a single beam.

The position reference sensor may further comprise a first telescope placed between the first laser and the beam combiner and a second telescope placed between the second laser and the beam combiner. This provides a straightforward, and high performance, means to control the size and divergence of the single beam, for example, to collimate the single beam so that is does not spread too wide before reaching a target. Alternatively, the position reference sensor may further comprise a single telescope placed after the beam combiner, so that the single beam is collimated using a single telescope which provides a more compact optical arrangement.

The target may be attached to an object. The object may be a vessel or a platform (such as an oil rig).

In order for the position reference sensor to determine the intensity of the first component of the light in the detected reflected light and the intensity of the second component of the light in the detected reflected light, the detector may further comprise a beam splitter configured to separate the first and second components of the light in the detected reflected light onto respective first and second photodetectors. Alternatively, the processor may be further configured to sequentially switch on and off the emission of the light of the first and second components, wherein the detector is configured to determine the intensity of the first component of the light in the detected reflected light in time periods where the emission of the first component is switched on and the emission of the second component is switched off, and to determine the intensity of the second component of the light in the detected reflected light in time periods where the emission of the second component of the light is switched on and the emissions of the first component of the light is switched off.

The light source may be configured to pulse the first component of the light, and optionally the second component of the light, and the processor may be configured to determine the distance based on time of flight of the emitted light and the detected reflected light. Alternatively, the light source may be configured to amplitude modulate the first component of the light, and optionally the second component of the light, and the processor may be configured to determine the distance based on a phase measurement on the emitted light and the detected reflected light.

The position reference sensor may be further configured to rotate the light source and the detector. By rotating the light source and the detector, the position reference sensor may hunt or scan for a target. The light source and the detector may be rotated using a rotation stage. The processor may determine the distance based on an average of the distance determined for each rotation of the detector.

The position reference sensor may comprise a movable optical element configured to scan the emitted light. By scanning the emitted light, the position reference sensor may hunt or scan for a target. The movable optical element may be one or more of: one or more scanning mirrors, one or more spinning polygon mirrors, a Risley prism, a Risley prism pair, and a spinning wedged optic.

The processor may be further configured to determine a bearing of the emitted light, in order that a bearing to the target may be determined. The position reference sensor may further comprise an encoder configured to determine the bearing.

The position reference system may further comprise a rotation stage configured to adjust an elevation angle of the light source and the detector. In this way, the position reference sensor may hunt or search for a selective retroreflector.

The processor may be further configured to output a signal indicative of the distance. This signal may be used, for example, to control a dynamic positioning system.

The processor may be further configured to output a signal indicating that the target is a selective retroreflector.

The position reference system may further comprise a dynamic positioning system configured to control the position and/or bearing of a vessel based on the signal indicative of the distance.

The position reference system may further comprise a dynamic position system configured to control the position and/or bearing of a vessel based on the signal indicative of the distance only when the dynamic positioning system also receives the signal indicating that the target is a selective retroreflector.

The position reference sensor may further comprise the light source.

The position reference sensor may further comprise the processor.

According to a third aspect of the invention, there is provided a method of determining whether a target to which a distance is measured is a selective retroreflector. The method comprises emitting light having a first component and a second component and detecting reflected light. The method further comprises determining a distance to a target based on the emitted light and the detected reflected light. The method further comprises determining that the target is a selective retroreflector based on the intensity of the first component of the light in the detected reflected light and the intensity of the second component of the light in the detected reflected light.

An advantage of the fact that light having a first component and a second component is emitted, that a distance to a target is determined based on the emitted light and the detected reflected light, and that the target is determined to be a selective retroreflector based on the intensity of the first component of the light in the detected reflected light and the intensity of the second component of the light in the detected reflected light means that the method is able to identify reflections that have come from a selective retroreflector and distinguish them from unwanted reflections. Measuring the distance to a selective retroreflector which may be fixed to an object is likely to provide a more reliable and stable indication of the distance to the object than measuring the distance to an unwanted reflection on the object, because the unwanted reflection may move relative to the object or the unwanted reflection may not be viewable over a wide-range of angles. The fact that the position reference sensor is able to identify reflections that have come from a selective retroreflector and distinguish them from unwanted reflections may eliminate the need for user intervention to identify a suitable retroreflective target.

The method may further comprise determining a ratio of the intensity of the first component of the light in the detected reflected light to the intensity of the second component of the light in the detected reflected light. The ratio may indicate whether the target is a selective retroreflector, or an unwanted reflection. For example, a ratio indicating that the intensity of the first component of the light in the detected reflected light is significantly higher than the intensity of the second component of the light in the detected reflected light may indicate that the target is a selective retroreflector. In contrast, a ratio indicating that the intensity of the first component of the light in the detected reflected light is similar to the intensity of the second component of the light in the detected reflected light may indicate that the target is an unwanted reflection.

The method may further comprise determining that the target is a selective retroreflector when the ratio of the intensity of the first component of the light in the detected reflected light to the intensity of the second component of the light in the detected reflected light is above an identification threshold. The identification threshold may be set so as to distinguish between targets which are, or are considered likely to be, selective retroreflectors, and targets which are, or might be, unwanted reflections.

The method may further comprise setting and/or adjusting the identification threshold based on the intensity of the first component of the light in the detected reflected light and/or the intensity of the second component of the light in the detected reflected light. The identification threshold may be adjusted to optimize discrimination between unwanted reflections and reflections from a selective retroreflector, while avoiding false results. For example, the identification threshold may be reduced when the intensity of the first component of the light in the detected reflected light and/or the intensity of the second component of the light in the detected reflected light is reduced.

The method may further comprise determining that the target is a selective retroreflector when the intensity of the first component of the light in the detected reflected light is above a first detection threshold and the intensity of the second component of the light in the detected reflected light is above a second detection threshold. The use of a detection threshold reduces the likelihood that background light (which has not come from the selective retroreflector), or noise on a detector, could lead to an erroneous determination that the target is a selective retroreflector.

The method may further comprise determining that the target is a selective retroreflector when the intensity of the first component of the light in the detected reflected light is above a first detection threshold and the intensity of the second component of the light in the detected reflected light is below a second detection threshold and the ratio of the intensity of the first component of the light in the detected reflected light to the second detection threshold is above the identification threshold.

The method may further comprise setting the first detection threshold and the second detection threshold to the same value.

Emitting light may further comprise emitting light where the first component has a first wavelength and the second component has a second wavelength. The first wavelength and the second wavelength can be selected to be any wavelengths, so long as the selective retroreflector reflects light of the first wavelength and not light of the second wavelength, or absorbs light of the second wavelength and not light of the first wavelength.

The method may further comprise selecting the first wavelength and the second wavelength such that atmospheric absorption is similar for both the first wavelength and the second wavelength.

The method may further comprise selecting the first wavelength and the second wavelength from the range of 850 nm to 2000 nm. The method may further comprise selecting the first wavelength from one of: 850 nm, 870 nm, 905 nm, 940 nm, 1064 nm, 1550 nm or 2000 nm. The method may further comprise selecting the second wavelength from one of: 850 nm, 870 nm, 905 nm, 940 nm, 1064 nm, 1550 nm or 2000 nm.

Emitting light may further comprise emitting light from a single laser which generates the light of the first wavelength and the light of the second wavelength. Alternatively, emitting light may further comprise emitting light from a first laser which generates the light of the first wavelength and a second laser which generates the light of the second wavelength.

One or more of the lasers may be selected to be a diode laser, such as: Laser Components 850D1S06x; Laser Components 905D; Osram 850 SPL PL85; Osram 905 SPL PL90; Hamamatsu L11348-307-05; or Hamamatsu L11854-307-05.

One or more of the lasers may be selected to be a Vertical Cavity Surface Emitting Laser array, which may operate in the range 900 nm-1000 nm.

One or more of the lasers may be selected to be a pulsed ND:YAG laser operating at 1064 nm.

One or more of the lasers may be selected to be a fibre laser operating at either 1550 nm or 2000 nm.

Emitting light may further comprise emitting light where the first component of the light has a first polarization state and the second component of the light has a second polarization state. The first polarization state and the second polarization state may be selected to be any polarization state, so long as the selective retroreflector reflects light of the first polarization state and not light of the second polarization state, or absorbs light of the second polarization state and not light of the first polarization state.

The first polarization state may be selected to be a linear polarization state with a first polarization axis. The second polarization state may be selected to be a linear polarization state with a second polarization axis which is orthogonal, or rotated, relative to the first polarization axis.

The first polarization state may be selected to be a left-handed circular, or elliptical, polarization state and the second polarization state a right-handed circular, or elliptical, polarization state. Alternatively, the first polarization state may be selected to be a right-handed circular, or elliptical, polarization state and the second polarization state may be a left-handed circular, or elliptical, polarization state.

Emitting light may further comprise emitting light from a laser which generates the light of the first polarization state and generating the light of the second polarization state from the light of the first polarization state using an optical element. The optical element may generate the second polarization state using a half-wave plate and a polarizer.

Emitting light may further comprise emitting light from a first laser and generating the light of the first polarization state using a first optical element, and emitting light from a second laser and generating the light of the second polarization state using a second optical element. The first optical element and the second optical element may be half-wave plates and polarizers, and/or quarter-wave plates.

Emitting light may further comprise emitting light of the first polarization state from a first laser having a polarization axis, and emitting light of the second polarization state from a second laser having a polarization axis, where the polarization axis of the second laser is rotated with respect to the polarization axis of the first laser. This is a straightforward and convenient way to provide a first and second polarization state, for example, by using the same laser for the first and second laser and physically rotating the second laser around the optical axis with respect to the first laser.

The method may further comprise combining the first and second components of light into a single beam.

The method may further comprise combining the first and second components of light into a single beam and controlling the size and/or divergence of the single beam. This provides a straightforward, and high performance, means to control the size and divergence of the single beam, for example, to collimate the single beam so that is does not spread too wide before reaching a target. Alternatively, the method may comprise controlling the size and/or divergence of the first and second components of the light before the first and second components of the light are combined into a single beam, which provides a more compact optical arrangement.

The method may further comprise separating the first and second components of the light, and separately detecting the intensity of the first and second components of the light. Alternatively, the method may comprise sequentially switching on and off the emission of the first and second components of the light, and detecting the intensity of the first component of the light in the detected reflected light in time periods where emission of the first component is switched on and emission of the second component is switched off, and determining the intensity of the second component of the light in the detected reflected light in times periods where the emission of the second component is switched on and the emission of the first component is switched off.

The method may further comprise pulsing the first component of the light, and optionally the second component of the light, and determining the distance based on time of flight of the emitted light and the detected reflected light. Alternatively, the method may further comprise amplitude modulating the first component of the light, and optionally the second component of the light, and determining the distance based on a phase measurement on the emitted light and the detected reflected light.

The method may further comprise rotating or scanning the emitted light, so as to hunt or scan for a target. The method may further comprise determining the distance based on an average of the distance determined for each rotation or scan of the emitted light.

The method may further comprise determining a bearing of the emitted light, in order that a bearing to the target may be determined.

The method may further comprise adjusting an elevation angle of the emitted light, so as to hunt or search for a selective retroreflector.

The method may further comprise outputting a signal indicative of the distance. This signal may be used, for example, to control a dynamic positioning system.

The method may further comprise outputting a signal indicating that the target is a selective retroreflector.

According to a fourth aspect of the invention, there is provided a method of determining whether a target to which a distance is measured is a selective retroreflector. The method comprises emitting light having a first component and a second component. The method further comprises configuring a target to be attachable to an object and configuring the target to retroreflect the first component of the light and not the second component of the light. The method further comprises detecting reflected light, determining a distance to the target based on the emitted light and the detected reflected light, and determining that the target is a selective retroreflector based on the intensity of the first component of the light in the detected reflected light and the intensity of the second component of the light in the detected reflected light.

An advantage of the fact that light having a first component and a second component is emitted, that the target is configured to reflect the light of the first component and not the light of the second component, that a distance to the target is determined based on the emitted light and the detected reflected light, and that the target is determined to be a selective retroreflector based on the intensity of the first component in the detected reflected light and the intensity of the second component in the detected reflected light means that the method is able to identify reflections that have come from a selective retroreflector and distinguish them from unwanted reflections. Measuring the distance to a selective retroreflector which is attachable to an object is likely to provide a more reliable and stable indication of the distance to the object than measuring the distance to an unwanted reflection from the object, because the unwanted reflection may move relative to the object or the unwanted reflection may not be viewable over a wide-range of angles. The fact that the position reference system is able to identify reflections that have come from a selective retroreflector and distinguish them from unwanted reflections may eliminate the need for user intervention to identify a suitable retroreflective target.

The method may further comprise determining a ratio of the intensity of the first component of the light in the detected reflected light to the intensity of the second component of the light in the detected reflected light. The ratio may indicate whether the target is a selective retroreflector, or an unwanted reflection. For example, a ratio indicating that the intensity of the first component of the light in the detected reflected light is significantly higher than the intensity of the second component of the light in the detected reflected light may indicate that the target is a selective retroreflector. In contrast, a ratio indicating that the intensity of the first component of the light in the detected reflected light is similar to the intensity of the second component of the light in the detected reflected light may indicate that the target is an unwanted reflection.

The method may further comprise determining that the target is a selective retroreflector when the ratio of the intensity of the first component of the light in the detected reflected light to the intensity of the second component of the light in the detected reflected light is above an identification threshold. The identification threshold may be set so as to distinguish between targets which are, or are considered likely to be, selective retroreflectors, and targets which are, or might be, unwanted reflections.

The method may further comprise setting and/or adjusting the identification threshold based on the intensity of the first component of the light in the detected reflected light and/or the intensity of the second component of the light in the detected reflected light. The identification threshold may be adjusted to optimize discrimination between unwanted reflections and reflections from a selective retroreflector, while avoiding false results. For example, the identification threshold may be reduced when the intensity of the first component of the light in the detected reflected light and/or the intensity of the second component of the light in the detected reflected light is reduced.

The method may further comprise determining that the target is a selective retroreflector when the intensity of the first component of the light in the detected reflected light is above a first detection threshold and the intensity of the second component of the light in the detected reflected light is above a second detection threshold. The use of a detection threshold reduces the likelihood that background light (which has not come from the selective retroreflector), or noise on a detector, could lead to an erroneous determination that the target is a selective retroreflector.

The method may further comprise determining that the target is a selective retroreflector when the intensity of the first component of the light in the detected reflected light is above a first detection threshold and the intensity of the second component of the light in the detected reflected light is below a second detection threshold and the ratio of the intensity of the first component of the light in the detected reflected light to the second detection threshold is above the identification threshold.

The method may further comprise setting the first detection threshold and the second detection threshold to the same value.

Configuring the target to retroreflect the first component of the light and not the second component of the light may comprise configuring the target with an optical component which reflects the first component of the light and not the second component of the light.

Emitting light may further comprise emitting light where the first component has a first wavelength and the second component has a second wavelength. The first wavelength and the second wavelength can be selected to be any wavelengths, so long as the selective retroreflector reflects light of the first wavelength and not light of the second wavelength, or absorbs light of the second wavelength and not light of the first wavelength.

The optical component may be selected to be a dielectric mirror which reflects the first component of the light and not the second component of the light. Alternatively, the optical component may be selected to be a band pass filter or a wavelength-absorbing material placed in front of a broadband mirror, where the band pass filter or the wavelength-absorbing material only allow the first component of the light to reach, and be reflected by, the broadband mirror. The wavelength-absorbing material may be selected to be a coloured glass filter or a coloured acrylic filter. The band pass filter may be a bandpass dichoric filter.

The method may further comprise selecting the first wavelength and the second wavelength such that atmospheric absorption is similar for both the first wavelength and the second wavelength.

The method may further comprise selecting the first wavelength and the second wavelength from the range of 850 nm to 2000 nm. The method may further comprise selecting the first wavelength from one of: 850 nm, 870 nm, 905 nm, 940 nm, 1064 nm, 1550 nm or 2000 nm. The method may further comprise selecting the second wavelength from one of: 850 nm, 870 nm, 905 nm, 940 nm, 1064 nm, 1550 nm or 2000 nm.

The light source may be a single laser which generates the light of the first wavelength and the light of the second wavelength. Alternatively, the light source may be a first laser which generates the light of the first wavelength and a second laser which generates the light of the second wavelength.

Emitting light may further comprise emitting light from a single laser which generates the light of the first wavelength and the light of the second wavelength. Alternatively, emitting light may further comprise emitting light from a first laser which generates the light of the first wavelength and a second laser which generates the light of the second wavelength.

One or more of the lasers may be selected to be a diode laser, such as: Laser Components 850D1S06x; Laser Components 905D; Osram 850 SPL PL85; Osram 905 SPL PL90; Hamamatsu L11348-307-05; or Hamamatsu L11854-307-05.

One or more of the lasers may be selected to be a Vertical Cavity Surface Emitting Laser array, which may operate in the range 900 nm-1000 nm.

One or more of the lasers may be selected to be a pulsed ND:YAG laser operating at 1064 nm.

One or more of the lasers may be selected to be a fibre laser operating at either 1550 nm or 2000 nm.

Emitting light may further comprise emitting light where the first component of the light has a first polarization state and the second component of the light has a second polarization state. The first polarization state and the second polarization state may be selected to be any polarization state, so long as the selective retroreflector reflects light of the first polarization state and not light of the second polarization state, or absorbs light of the second polarization state and not light of the first polarization state.

The first polarization state may be selected to be a linear polarization state with a first polarization axis. The second polarization state may be selected to be a linear polarization state with a second polarization axis which is orthogonal, or rotated, relative to the first polarization axis.

The first polarization state may be selected to be a left-handed circular, or elliptical, polarization state and the second polarization state a right-handed circular, or elliptical, polarization state. Alternatively, the first polarization state may be selected to be a right-handed circular, or elliptical, polarization state and the second polarization state may be a left-handed circular, or elliptical, polarization state.

The optical component in the selective retroreflector may be selected to be a polarizing beamsplitter which reflects the first component of the light and not the second component of the light. Alternatively, the optical component in the selective retroreflector may be selected to be a polarizer which is placed in front of a broadband mirror, where the polarizer only allows the first component of the light to reach, and be reflected by, the broadband mirror.

Emitting light may further comprise emitting light from a laser which generates the light of the first polarization state and generating the light of the second polarization state from the light of the first polarization state using an optical element. The optical element may generate the second polarization state using a half-wave plate and a polarizer.

Emitting light may further comprise emitting light from a first laser and generating the light of the first polarization state using a first optical element, and emitting light from a second laser and generating the light of the second polarization state using a second optical element. The first optical element may generate the light of the first polarization state and the second optical elements may generate the light of the second polarization state using half-wave plates and polarizers, and/or quarter-wave plates.

Emitting light may further comprise emitting light of the first polarization state from a first laser having a polarization axis, and emitting light of the second polarization state from a second laser having a polarization axis, where the polarization axis of the second laser is rotated with respect to the polarization axis of the first laser. This is a straightforward and convenient way to provide a first and second polarization state, for example, by using the same laser for the first and second laser and physically rotating the second laser around the optical axis with respect to the first laser.

The method may further comprise combining the first and second components of light into a single beam.

The method may further comprise combining the first and second components of light into a single beam and controlling the size and/or divergence of the single beam. This provides a straightforward, and high performance, means to control the size and divergence of the single beam, for example, to collimate the single beam so that is does not spread too wide before reaching a target. Alternatively, the method may comprise controlling the size and/or divergence of the first and second components of the light before the first and second components of the light are combined into a single beam, which provides a more compact optical arrangement.

The method may further comprise attaching the target to an object. The object may be a vessel or a platform (such as an oil rig).

The method may further comprise separating the first and second components of the light, and separately detecting the intensity of the first and second components of the light. Alternatively, the method may comprise sequentially switching on and off the emission of the first and second components of the light, and detecting the intensity of the first component of the light in the detected reflected light in time periods where emission of the first component is switched on and emission of the second component is switched off, and determining the intensity of the second component of the light in the detected reflected light in times periods where the emission of the second component is switched on and the emission of the first component is switched off.

The method may further comprise pulsing the first component of the light, an optionally the second component of the light, and determining the distance based on time of flight of the emitted light and the detected reflected light. Alternatively, the method may further comprise amplitude modulating the first component of the light, and optionally the second component of the light, and determining the distance based on a phase measurement on the emitted light and the detected reflected light.

The method may further comprise rotating or scanning the emitted light, so as to hunt or scan for a target. The method may further comprise determining the distance based on an average of the distance determined for each rotation or scan of the emitted light.

The method may further comprise determining a bearing of the emitted light, in order that a bearing to the target may be determined.

The method may further comprise adjusting an elevation angle of the emitted light, so as to hunt or search for a selective retroreflector.

The method may further comprise outputting a signal indicative of the distance. This signal may be used, for example, to control a dynamic positioning system.

The method may further compose outputting a signal indicating that the target is a selective retroreflector.

The method may further comprise controlling the position and/or bearing of a vessel based on the signal indicative of the distance using a dynamic positioning system.

The method may further comprise controlling the position and/or bearing of a vessel based on the signal indicative of the distance using a dynamic positioning system only when the dynamic positioning system also receives the signal indicating that the target is a selective retroreflector.

According to a fifth aspect of the invention, there is provided a computer readable medium containing instructions which, when executed by a processor, cause the processor to carry out a method according to the third or fourth aspects of the invention.

### BRIEF DESCRIPTION OF THE DRAWINGS

The invention shall now be described, by way of example only, with reference to the accompanying drawings, in which:

FIG. 1 illustrates a position reference sensor according to an embodiment of the invention where a beam from the position reference sensor is reflected by a reflective surface on an object;

FIG. 2 is an example of a bar chart of intensity of light at a first wavelength and intensity of light at a second wavelength as measured by a detector for an unwanted reflection;

FIG. 3 illustrates the position reference sensor of FIG. 1 where the beam from the position reference sensor is reflected by a selective retroreflector;

FIG. 4 is an example of a bar chart of intensity of light at the first wavelength and intensity of light at the second wavelength as measured by a detector for a reflection from a selective retroreflector;

FIG. 5 illustrates a position reference sensor, such as the position reference sensor of FIG. 1;

FIG. 6 illustrates a position reference sensor, such as the position reference sensor in FIG. 3; and

FIG. 7 illustrates the use of a position reference sensor and a dynamic positioning system to control the position of a vessel relative to an object.

### DETAILED DESCRIPTION

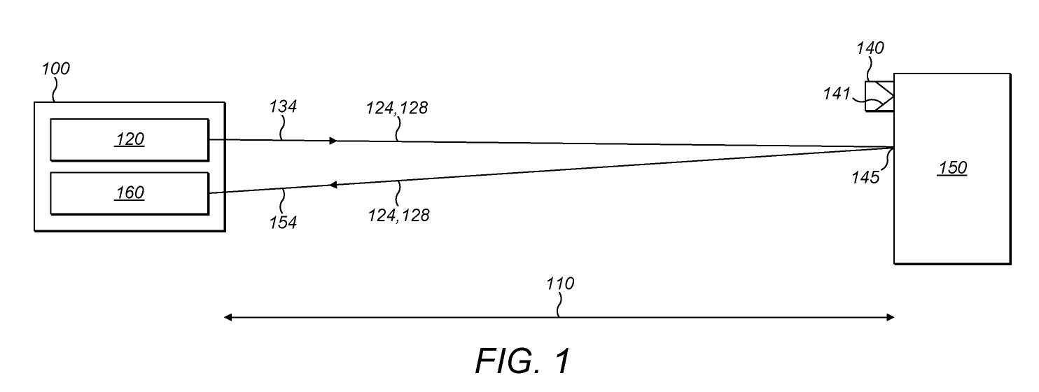

FIG. 1 shows a position reference sensor 100 being used to determine a distance 110 between the position reference sensor 100 and a point 145 on object 150.

The position reference sensor 100 has a light source 120 which emits a beam of light 134 containing light at two different wavelengths—a first wavelength 124 and a second wavelength 128.

The beam 134 is directed towards the object 150. A selective retroreflector 140 is attached to the object 150. The selective retroreflector 140 has dielectric mirrors 141 which have been chosen to reflect the first wavelength 124 but not the second wavelength 128.

As well as the selective retroreflector 140, the object 150 has a variety of other reflective surfaces or elements (such as point 145) which can lead to an unwanted reflection 154 which does not come from the selective retroreflector 140. The unwanted reflection 154 is not a good choice for the position reference sensor 100 to use for determining the distance to the object 150. The unwanted reflection 154 may not provide a reliable reference point on the object 150 because, for example, the reference point could move or may not be viewable from a wide-range of angles.

Reflective surface 145 is a retroreflective material (such as a retro-reflective tape), or a polished metal surface or a glass surface. Retroreflective materials, and metal and glass surfaces, are typically broadband reflectors which are reflective over a wide range of wavelengths and will therefore reflect light of both the first wavelength 124 and the second wavelength 128. Hence, unwanted reflections, such as unwanted reflection 154, will contain light of both the first wavelength 124 and the second wavelength 128.

The unwanted reflection 154 is reflected back to the position reference sensor 100 where it hits a detector 160. The detector 160 measures the intensity of light in the first wavelength 124 and the intensity of the light in the second wavelength 128.

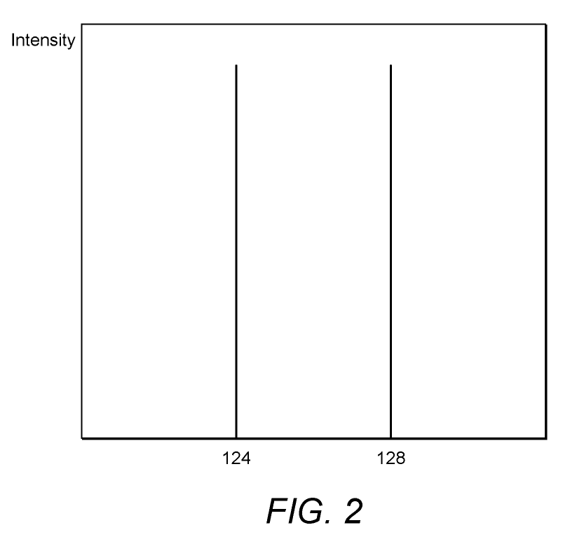

FIG. 2 is a bar chart illustrating the intensity of light at the first wavelength 124 and the intensity of light at the second wavelength 128 as received at the detector 160. The fact that the detector 160 detects light at both the first wavelength 124 and the second wavelength 128 indicates that the reflection is an unwanted reflection rather than a reflection from a selective retroreflector.

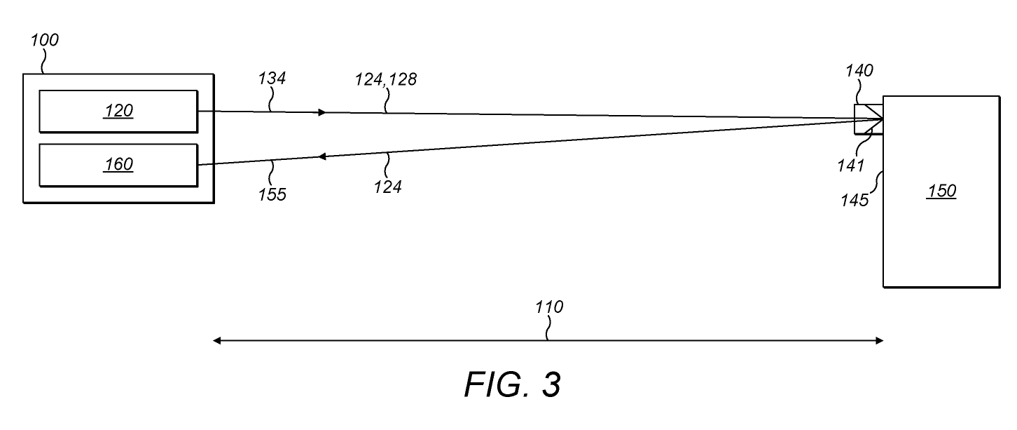

FIG. 3 shows the position reference sensor 100 and the object 150 of FIG. 1. In FIG. 3, the position reference sensor 100 has moved with respect to the object 150, for example, because a vessel to which the position reference sensor 100 is attached has moved in response to wind, waves and/or current, or because the orientation of the position reference sensor 100 has been altered.

The beam 134 is directed towards the object 150 and now hits the selective retroreflector 140. The dielectric mirror 141 in the selective retroreflector 140 reflects light of the first wavelength 124 but not light of the second wavelength 128.

The reflection 155 from the selective retroreflector 140 is reflected straight back to the position reference sensor 100 where it hits the detector 160. Reflections from the selective retroreflector 140 can be distinguished from unwanted reflections, such as unwanted reflection 154 from reflective surface 145, because reflection 155 from the selective retroreflector 140 will only contain light of the first wavelength 124.

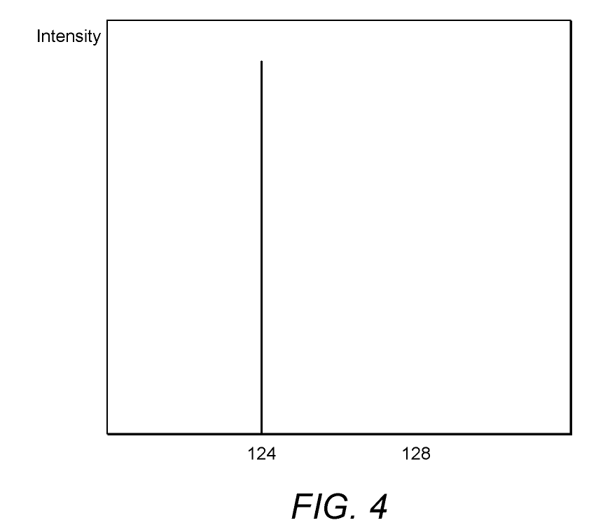

FIG. 4 is a bar chart illustrating the intensity of light at the first wavelength 124 and the intensity of light at the second wavelength 128 as received at the detector 160. The fact that the detector 160 only detects light at the first wavelength 124 indicates that the reflection is a reflection from a selective retroreflector.

The position reference sensor 100 determines whether a reflection is an unwanted reflection or a reflection from a selective retroreflector by comparing the intensity of light at the first wavelength 124 with the intensity of the light at the second wavelength 128. The position reference sensor 100 may determine a ratio of the intensity of light at the first wavelength 124 to the intensity of the light at the second wavelength 128. If the ratio of the intensity of light at the first wavelength 124 to the intensity of the light at the second wavelength 128 is greater than an identification threshold, the reflection is determined as coming from a selective retroreflector. Otherwise, the reflection is determined as being an unwanted reflection.

The position reference sensor 100 calculates the distance 110 by pulsing the light source 120 and measuring a time of flight between the emission of a pulse by the light source 120 and receipt of the pulse by the detector 160. The position reference sensor 100 has an output which indicates the distance 110 and whether the distance 110 is a distance to a selective retroreflector, or a distance to an unwanted reflection.

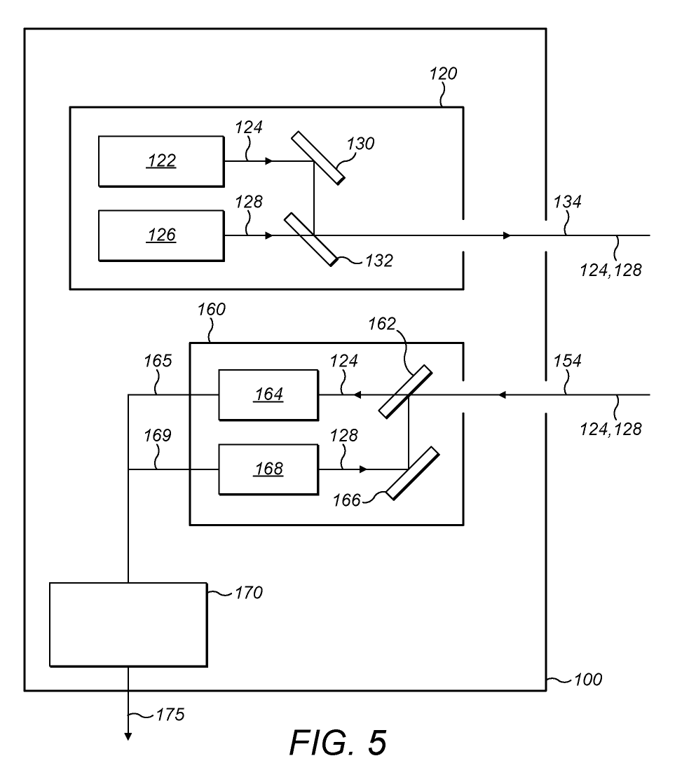

FIG. 5 shows an example of a position reference sensor, such as the position reference sensor 100 shown in FIG. 1.

The position reference sensor 100 has a light source 120 with two lasers—a first laser 122 and a second laser 126—which emit light at different wavelengths. The first laser 122 emits light at a first wavelength 124 and the second laser 126 emits light at a second wavelength 128. The light from the first laser 122 and the second laser 126 is combined into a single beam 134, containing both light of the first wavelength 124 and light of the second wavelength 128, using a mirror 130 and a beam combiner 132.

The beam 134 is directed towards the object 150. If, as in FIG. 1, the beam 134 misses the selective retroreflector 140 and hits the point 145, the point 145 reflects both light of the first wavelength 124 and light of the second wavelength 128 so the reflected beam 154 contains both light of the first wavelength 124 and light of the second wavelength 128. The reflected beam 154 hits the detector 160 on the position reference sensor 100.

The detector 160 has two photodetectors—a first photodetector 164 and a second photodetector 168. A beamsplitter 162 separates light of the first wavelength 124 from light of the second wavelength 128. The light of the first wavelength 124 passes through the beamsplitter 162 to the first photodetector 164. The light of the second wavelength 128 is reflected by the beamsplitter 162 and mirror 166 onto the second photodetector 168.

The first photodetector 164 generates an output voltage 165, which is related to the intensity of the light at the first wavelength 124 incident on the first photodetector 164. The second photodetector 168 generates an output voltage 169, which is related to the intensity of the light at the second wavelength 128 incident on the second photodetector 168. The output voltages 165 and 169 are passed to processor 170.

The processor 170 determines whether a reflection is an unwanted reflection or a reflection from a selective retroreflector by determining a ratio of the output voltages 165 and 169. The ratio of the output voltages 165 and 169 is less than an identification threshold, which indicates that the reflected beam 154 is an unwanted reflection and is not from a selective retroreflector 140.

The processor 170 has an output 175 which indicates the distance 110, and which indicates that the distance 110 is a distance to an unwanted reflection. The output 175 can be used as an input to a dynamic positioning system to control the position of a vessel.

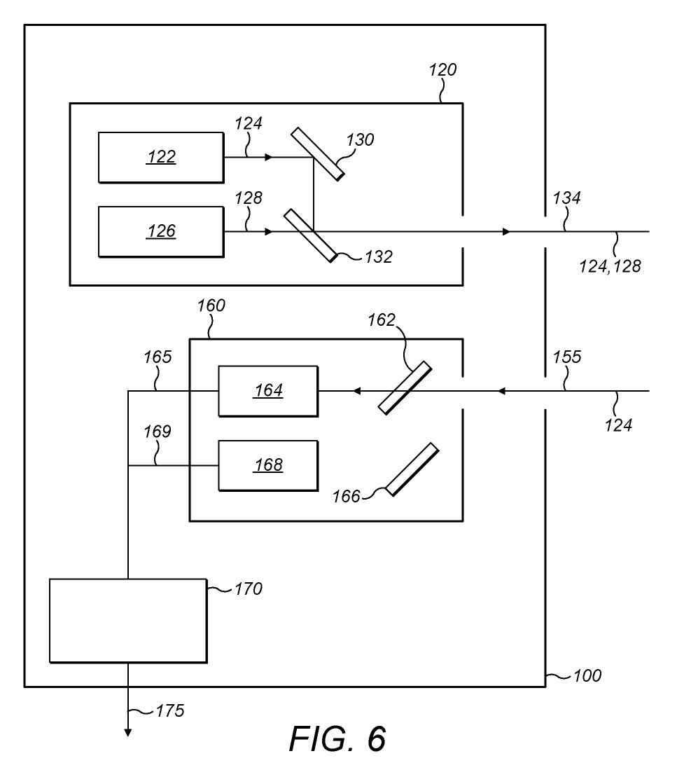

FIG. 6 shows an example of a position reference sensor 100, when the beam 134 hits the selective retroreflector 140, as illustrated in FIG. 3.

The dielectric mirror 141 in the selective retroreflector 140 reflects only light of the first wavelength 124, so the reflected beam 155 only contains light of the first wavelength 124. The reflected beam 155 hits the detector 160 on the position reference sensor 100.

The beamsplitter 162 allows the light of the first wavelength 124 to pass through the beamsplitter. There is no light of the second wavelength 128 to be directed via mirror 166 onto the second photodetector 168.

The first photodetector 164 generates an output voltage 165, which is related to the intensity of the light of the first wavelength 124 incident on the first photodetector 164. As the reflected beam 155 only contain light of the first wavelength 124, the second photodetector 168 will not generate an output voltage 169, or will only generate a very low output voltage 169 as a result of noise. The output voltages 165 and 169 are passed to processor 170.

The processor 170 determines whether a reflection is an unwanted reflection or a reflection from a selective retroreflector by determining a ratio of the output voltages 165 and 169. The ratio of the output voltages 165 and 169 is greater than an identification threshold, which indicates that the reflected beam 154 is a reflection from a selective retroreflector 140. The processor 170 will use the reflected beam 155 to determine the distance 110.

The processor 170 has an output 175 which indicates the distance 110, and which indicates that the distance 110 is a distance to a selective retroreflector. The output 175 can be used as an input to a dynamic positioning system to control the position of a vessel.

The first photodetector 164 and the second photodetector 168 will have respective noise floors. A detection threshold may be applied to the output voltages 165 and 169 to discriminate between noise and signals relating to the light of the first wavelength 124 and light of the second wavelength 128.

The processor 170 identifies that a reflection is from a selective retroreflector, if the output voltage 165 (relating to the light of the first wavelength 124) and the output voltage 169 (relating to the light of the second wavelength 128) are greater than the detection threshold, and the ratio of the output voltage 165 to the output voltage 169 is greater than the identification threshold.

The processor 170 identifies that a reflection is an unwanted reflection, if the output voltage 165 (relating to the light of the first wavelength 124) and the output voltage 169 (relating to the light of the second wavelength 128) are greater than the detection threshold, and the ratio of the output voltage 165 to the output voltage 169 is less than the identification threshold.

The processor 170 cannot identify with certainty that a reflection is from a selective retroreflector or an unwanted reflection when the output voltage 165 (relating to the light of the first wavelength 124) is greater than the detection threshold but the output voltage 169 (relating to the light of the second wavelength 128) is less than the detection threshold, because the ratio between the output voltage 165 and the output voltage 169 cannot be determined.

However, the processor 170 may also identify that a reflection is from a selective retroreflector if the output voltage 165 (relating to the light of the first wavelength 124) is greater than the detection threshold and the output voltage 169 (relating to the light of the second wavelength 128) is less than the detection threshold, but the ratio of the output voltage 165 to the detection threshold is greater than the identification threshold. If the output voltage 165 is greater than the detection threshold and the output voltage 169 is less than the detection threshold, but the ratio of the output voltage 165 to the detection threshold is less than the identification threshold, the processor 170 may determine that there has been a reflection but cannot identify whether the reflection is from a selective retroreflector or a unwanted reflection.

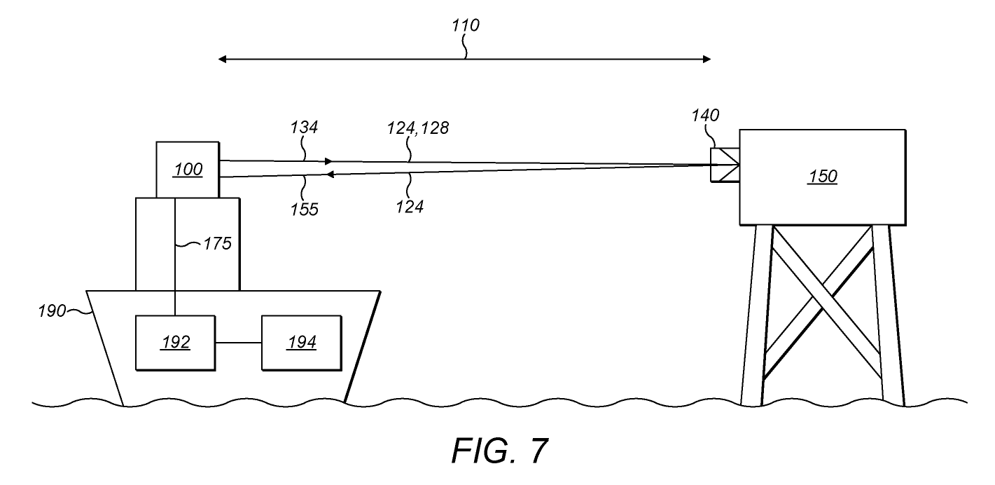

FIG. 7 shows an example of a system for controlling the position of a vessel 190 using a position reference sensor 100.

The position reference sensor 100 measures the distance 110 between the position reference sensor 100 and points on the object 150, as discussed in relation to FIGS. 1, 3, 5 and 6 above, and determines whether these points relate to selective retroreflectors or unwanted reflections. The output 175 from the position reference sensor 100 can be fed into a dynamic positioning system 192 which uses the output 175 in a feedback loop to control the engine and thrusters 194 of the vessel 190 in order to control the position of the vessel 190 relative to the object 150.

The system may include a display which shows a user the object 150. The display may show the location of one or more selective retroreflectors. The display may mark items on the display, to indicate whether the item is a selective retroreflector or an unwanted reflection. If the system is unable to identify whether an item is a selective retroreflector or an unwanted reflection, the system may mark the item accordingly. The system may allow the user to select an item (such as a selective retroreflector) using the display to which the position is to be controlled. If the system is unable to find any selective retroreflectors, the system may instruct the user to select an appropriate item on the display to which the position is to be controlled.

Although the invention has been described in terms of certain preferred embodiments, the skilled person will appreciate that various modifications could be made while remaining within the scope of the claims.

The first wavelength and the second wavelength can be chosen to be any wavelengths, so long as a suitable dielectric mirror 141 can be found for the selective retroreflector which reflects one wavelength and not the other, or at least that the dielectric mirror reflects one wavelength substantially more than the other wavelength.

It may be advantageous to pick first and second wavelengths where atmospheric absorption is similar for both the first and second wavelengths.

Alternatively, it may be advantageous to pick wavelengths where laser diodes are cheap and readily available. For example, the first wavelength may be one of: 850 nm, 870 nm, 905 nm, and 940 nm. The second wavelength may be one of: 905 nm, 940 nm, 980 nm, and 1064 nm. Suitable diode lasers include: Laser Components 850D1S06x; Laser Components 905D; Osram 850 SPL PL85; Osram 905 SPL PL90; Hamamatsu L11348-307-05; and Hamamatsu L11854-307-05.

A Vertical Cavity Surface Emitting Laser array may be used for one or more of the lasers in the range 900 nm-1000 nm.

A pulsed ND:YAG laser may be used as a source for 1064 nm. Alternatively, fibre lasers at 1550 nm or 2000 nm could be used.

A first telescope may be placed after the first laser 122 and a second telescope after the second laser 126 (before combining the beam from the first laser 122 and the beam from the second laser 126 into beam 134). This provides a straightforward, and high performance, means to control the size and divergence of the beam 134, for example, to collimate the beam 134 so that is does not spread too wide before reaching the target 150. Alternatively, the first laser 122 and the second laser 126 may be combined, and the beam 134 collimated using a single telescope, which provides a more compact optical arrangement.

A band pass dichroic filter, such as those available from Omega Filters, could be used instead of the dielectric mirror 141 in the selective retroreflector 140.

Although the selective retroreflector 140 has been described as having a dielectric mirror 141, a wavelength-absorbing material, such as a coloured glass filter or a coloured acrylic filter, could be used in front of a broadband mirror. The coloured glass or acrylic filter would be chosen to absorb light of the second wavelength 128.

Although the light source 120 has been described as having a first laser 122 (which generates a first wavelength 124) and a second laser 128 (which generates a second wavelength 128), the light source 120 could instead have a single laser (which generates both the first wavelength 124 and the second wavelength 128).

Instead of distinguishing between unwanted reflections and reflections from a selective retroreflector 140 using a beam 134 containing two different wavelengths (as described above), the beam 134 could instead contain two different polarization states. For example, the beam 134 could contain a first polarization state and a second polarization state, with a selective retroreflector 140 including an optical component which reflects only the first polarization state, or absorbs the second polarization state.

The first polarization state may be a linear polarization state with a first polarization axis, and the second polarization state may be a linear polarization state with a second polarization axis which is orthogonal, or rotated, relative to the first polarization axis. The light source 120 could have two separate lasers, where one laser produces a first linear polarization state and the second laser produces a second linear polarization state. Otherwise, the light source 120 could have one laser which is linearly polarized and generates the first polarization state and an optical element, such as a beamsplitter and half-wave plate, which produces the second component with the second polarization state. Alternatively, the light source 120 could have a first laser producing linearly polarized light along a first polarization axis, and a second laser with a second polarization axis which is the same as the first polarization axis, where the second laser is rotated relative to the first laser so that the second polarization axis is orthogonal, or rotated, relative to the first polarization axis.

The first polarization state may be a left-handed circular, or elliptical, polarization state, and the second polarization state may be a right-handed circular, or elliptical, polarization state, which may be generated by placing quarter-wave plates in front of the first laser 122 and the second laser 126.

The detector 160 has been described as having a first photodetector 164 to measure the intensity of light of the first wavelength 124 and a second photodetector 168 to measure the intensity of light of the second wavelength 128 in the reflected beam. Alternatively, the detector 160 could be a single broadband detector. The detector could sequentially switch on and off the light of the first wavelength 124 and the light of the second wavelength 128 (for example, by sequentially switching on and off the first laser 122 and the second laser 126). The detector could determine the intensity of the light of the first wavelength 124 in time periods where the light of the first wavelength 124 is switched on (while the light of the second wavelength 128 is switched off) and the intensity of the light of the second wavelength 128 in times periods where the light of the second wavelength 128 is switched on (while the light of the first wavelength 124 is switched off).

A correction may be applied to the detector to account for any difference in detection efficiency at the first and second wavelengths, and/or any differences in transmission and/or reflection efficiencies of any optical components.

Although the invention has been described as determining the distance 110 using time of flight, the distance 110 could be determined by amplitude modulating the light source 120 and determining the distance based on a phase measurement of the light emitted by the light source 120 and the light detected by the detector 160.

Pulsing the light source 120 may mean pulsing the light at the first wavelength 124 and the light at the second wavelength 128, and measuring a time of flight between the emission of a pulse by the light source 120 and receipt of the pulse by the detector 160.

The identification threshold may be adjusted to optimize discrimination between unwanted reflections and reflections from selective retroreflector, while avoiding false results. For example, the identification threshold may be lowered when the intensity of the light at the first wavelength 124 or the intensity of the light at the second wavelength reduces.

Although the invention has been described as having a single detection threshold for both the light of the first wavelength 124 and the light of the second wavelength 128, there could be a first detection threshold for the light of the first wavelength 124 and a second detection threshold for the light of the second wavelength 128. This could be useful if, for example, one of the wavelengths is likely to be attenuated, for example, by atmospheric absorption.

In order to scan for objects, the light source 120 and the detector 160, or indeed the entire position reference sensor 100, could be rotated, for example, using a rotation stage. The position reference sensor may determine a bearing to the object 150 by reading the rotational orientation from an encoder on the rotation stage.

Alternatively, the beam 134 could be scanned using one or more movable optical elements. For example, the beam 134 could be scanned using: one or more scanning mirrors; one or more spinning polygon mirrors; a Risley prism pair to scan the beam in two axes; or a spinning wedged optic to scan the beam in a circle. The position reference sensor 100 may determine a bearing to the object 150 from the reading on an encoder attached to one or each of the one or more movable optical elements.

The position reference sensor 100 may determine the distance 110 based on an average of the distance determined for a number of rotations or scans, in order to improve the accuracy of the distance determined.

The position reference sensor 100 may scan vertically looking for a reflection from a selective retroreflector in order to pinpoint an object 150.

Each of the photodetectors 164 may comprise a plurality of photodiodes (such as three photodiodes) arranged vertically, in order to increase the chance that a reflection will hit the photodetector 164 and to provide information (based on the relative intensity recorded by each photodiode) about the inclination of the object 150 with respect to the position reference sensor 100.

The beam 134 may be spread in the vertical direction to increase the chance of the beam 134 hitting a selective retroreflector.

1. A position reference sensor comprising:
a light source configured to emit light having a first component and a second component;
a detector configured to detect reflected light; and
a processor configured to determine a distance between the position reference sensor and a target based on the emitted light and the detected reflected light, wherein the processor is further configured to determine that the target is a selective retroreflector based on the intensity of the first component of the light in the detected reflected light and the intensity of the second component of the light in the detected reflected light.

2. The position reference sensor of claim 1, wherein the processor is further configured to determine a ratio of the intensity of the first component of the light in the detected reflected light to the intensity of the second component of the light in the detected reflected light.

3. The position reference sensor of claim 2, wherein the processor is further configured to determine that the target is a selective retroreflector when the ratio of the intensity of the first component of the light in the detected reflected light to the intensity of the second component of the light in the detected reflected light is above an identification threshold.

4. The position reference sensor of claim 3, wherein the processor is further configured to adjust the identification threshold based on the intensity of the first component of the light in the detected reflected light and/or the intensity of the second component of the light in the detected reflected light.

5. The position reference sensor of claim 1, wherein the processor is further configured to determine that the target is a selective retroreflector when the intensity of the first component of the light in the detected reflected light and the intensity of the second component of the light in the detected reflected light is above a detection threshold.

6. The position reference sensor of claim 1, wherein the processor is further configured to determine that the target is a selective retroreflector when the intensity of the first component of the light in the detected reflected light is above a first detection threshold and the intensity of the second component of the light in the detected reflected light is below a second detection threshold and the ratio of the intensity of the first component of the light in the detected reflected light to the second detection threshold is above the identification threshold.

7. The position reference sensor of claim 1, wherein the first component of the emitted light has a first wavelength and the second component of the emitted light has a second wavelength, preferably wherein the light source either comprises a laser configured to generate the light of the first wavelength and the light of the second wavelength, or comprises a first laser configured to generate the light of the first wavelength and a second laser configured to generate the light of the second wavelength.

8. The position reference sensor of claim 1, wherein the first component of the light has a first polarization state and the second component of the light has a second polarization state, preferably wherein either the light source comprises a laser configured to generate the light of the first polarization state and an optical element configured to generate the light of the second polarization state from the light of the first polarization state, or the light source comprises a first laser and a first optical element configured to generate the light of the first polarization state, and a second laser and a second optical element configured to generate the light of the second polarization state, or the light of the first polarization state is generated by a first laser having a polarization axis, and the second polarization state is generated by a second laser having a polarization axis, wherein the polarization axis of the second laser is rotated with respect to the polarization axis of the first laser.

9. (canceled)

10. The position reference sensor of claim 1, wherein the detector comprises a beam splitter configured to separate light of the first and second components in the detected reflected light onto respective first and second photodetectors.

11. The position reference sensor of claim 1, wherein the processor is configured to sequentially switch on and off the emission of the first and second components of the light, wherein the detector is configured to determine the intensity of the first component of the light in the detected reflected light in time periods where the emission of the light of the first component is switched on and the emission of the light of the second component is switched off, and to determine the intensity of the second component of the light in the detected reflected light in times periods where the emission of the light of the second component is switched on and the emission of the light of the first component is switched off.

12. The position reference sensor of claim 1, wherein the first component of the light is pulsed and the processor is configured to determine the distance based on time of flight of the emitted light and the detected reflected light.

13. The position reference sensor of claim 1, wherein the first component of the light is amplitude modulated and the processor is configured to determine the distance based on a phase measurement on the emitted light and the detected reflected light.

14. The position reference sensor of claim 1, wherein the position reference sensor is further configured to rotate the light source and the detector.

15. The position reference sensor of claim 1, further comprising a movable optical element configured to scan the emitted light.

16. The position reference sensor of claim 15, wherein the movable optical element comprises any of: a scanning mirror, a spinning polygon mirror, a Risley prism, and a spinning wedged optic.

17. The position reference sensor of claim 1, wherein the processor is further configured to determine a bearing of the emitted light.

18. The position reference sensor of claim 1, further comprising a rotation stage configured to adjust an elevation angle of the light source and the detector.

19. The position reference sensor of claim 1, wherein the processor is further configured to output a signal indicative of the distance.

20. A position reference system comprising:
a light source configured to emit light having a first component and a second component;
a target configured to be attachable to an object, the target further configured to retroreflect the first component of the light and not the second component of the light;
a position reference sensor of claim 1; and
a processor configured to determine a distance between the position reference sensor and the target based on the emitted light and the detected reflected light, wherein the processor is further configured to determine that the target is a selective retroreflector based on the intensity of the first component of the light in the detected reflected light and the intensity of the second component of the light in the detected reflected light.
